(19) United States
(12) Patent Application Publication
(10) Pub. No.: US 2004/0012202 A1
(43) Pub. Date: Jan. 22, 2004

(54) Highway electric roller

(76) Inventor: Sherrill R. Dobbs SR., Glen Easton, WV (US)

Correspondence Address: Sherrill R. Dobbs, Sr., RD1 - Box 164, Glen Easton, WV, 26039, US

(21) Appl. No.: 10/385,397

(22) Filed: Mar. 10, 2003

Related U.S. Application Data
(60) Provisional application No. 60/363,207, filed on Mar. 12, 2002.

(51) Int. Cl. H02P 9/04

(52) U.S. Cl. 290/1 R

(57) ABSTRACT

A method for generating electrical power by the use of several installed rollers placed in Highway. Vehicles will turn said rollers that will turn a shaft that will operate several placed generators. The result is electric power by the use of Highway vehicle traffic. In Addition, hydraulics and computers will raise and or lower the rollers to obtain the efficient roller speed to maximize electrical generation.

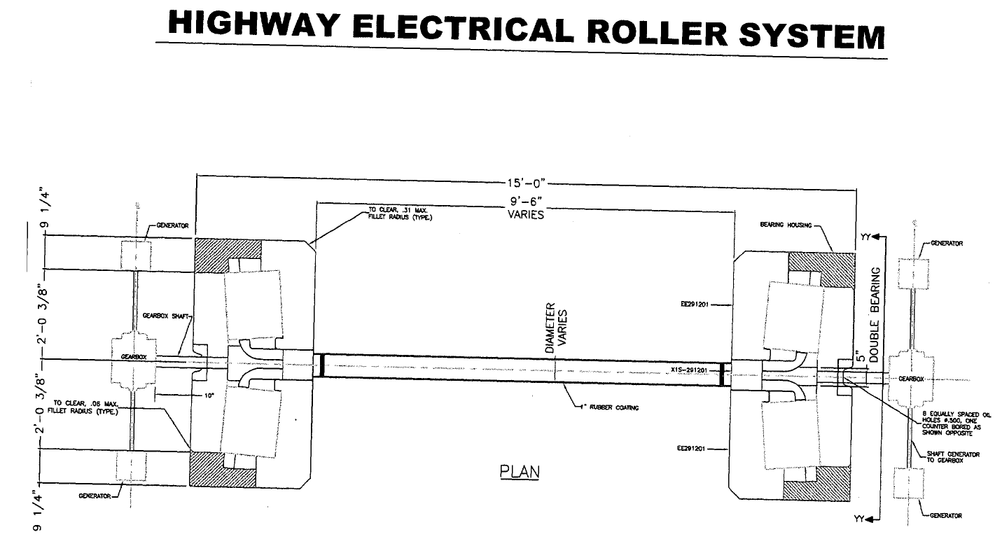

A method for generating electrical power by the use of several installed rollers placed in a Highway. Vehicles will turn said rollers that will turn a shaft that will operate several placed electrical generators. The result is electric power by the use of Highway vehicle traffic.

In Addition, Hydraulics and computers will raise and or lower the rollers to obtain the efficient roller speed to maximize electrical generation.

1. I, Sherrill R. Dobbs Sr. make the claim to the right of the Highway Electric Roller Invention. I have invented a concept to generate electricity by turning rollers placed beneath the Highway, a minimal part of the roller above surface of the Highway which shall rotate when vehicle traffic passes over the rollers. The rollers will turn a shaft that will operate a generator which will create electrical energy. The use of this Highway Electrical System will create low cost electrical energy to be provided to the public by the use of Highway traffic. The electric generated can be stored in grids or moved to transformers to be sent further.
